(19) United States
(12) Patent Application Publication
(10) Pub. No.: US 2025/0243088 A1
(43) Pub. Date: Jul. 31, 2025

(54) METHOD AND APPARATUS FOR WATER CLARIFICATION AND GREENING

(71) Applicants: FujiClean Co., Ltd., Aichi (JP); HIROSHIMA UNIVERSITY, Hiroshima (JP); THE CHUGOKU ELECTRIC POWER CO., INC., Hiroshima (JP)

(72) Inventors: Tsuyoshi ICHINARI, Aichi (JP); Hiroyuki SAITO, Aichi (JP); Akiko NAGAOKA, Aichi (JP); Mayu ISHIDA, Aichi (JP); Satoshi ASAOKA, Hiroshima (JP); Shota MIYAMOTO, Hiroshima (JP)

(73) Assignees: FujiClean Co., Ltd., Aichi (JP); HIROSHIMA UNIVERSITY, Hiroshima (JP); THE CHUGOKU ELECTRIC POWER CO., INC., Hiroshima (JP)

(21) Appl. No.: 18/854,428

(22) PCT Filed: Jun. 9, 2023
(86) PCT No.: PCT/JP2023/021458

§ 371 Date: Oct. 4, 2024

(30) Foreign Application Priority Data
Jun. 10, 2022 (JP) 2022-094505

(51) Int. Cl. C02F 1/28; A01C 23/04; B01J 20/10; C02F 101/10; C02F 101/16; C02F 103/00; C05B 15/00; C05C 1/00

(52) U.S. Cl. CPC C02F 1/281; A01C 23/04; B01J 20/103; C05B 15/00; C05C 1/00; C02F 2101/101; C02F 2101/105; C02F 2101/16; C02F 2103/005

(57) ABSTRACT

It is an object of the present invention to provide a method for water clarification and greening that can simply and efficiently adsorb and remove nitrogen and/or phosphorus in a smaller horizontal area than in conventional methods, and that exhibits improved water clarification performance per unit area. It is also an object of the present invention to provide a method for water clarification and greening that can stably adsorb and remove nitrogen and/or phosphorus not only in summer but also in winter.

The present invention relates to a method for water clarification and greening, which simultaneously achieves water clarification and greening by planting a plant in a channel; wherein water flowing into the channel contains ammonia nitrogen and/or phosphorus; the channel comprises a planting portion where the plant is planted in a filtration bed filled with a granular material containing incineration ash; and the granular material containing incineration ash adsorbs the ammonia nitrogen and/or phosphorus in the water flowing into the channel, and the plant grows by absorbing the ammonia nitrogen and/or phosphorus adsorbed onto the granular material containing incineration ash, so as to achieve water clarification and greening.

### TECHNICAL FIELD

The present invention relates to a method and an apparatus for water clarification and greening.

### BACKGROUND ART

From the viewpoint of preventing eutrophication of rivers, lakes, marshes, and other closed water bodies to preserve the water environment and water quality, removal of pollutants, especially nitrogen or phosphorus, in domestic wastewater is an urgent issue.

Patent Literature 1 proposes a method for removing nitrogen or phosphorus in eutrophic water, wherein phosphoric acid contained in the eutrophic water is adsorbed using fly ash of a particle diameter having a double structure in which fine particles are incorporated into a hollow of a hollow particle structure.

However, the method for removing phosphoric acid disclosed in Patent Literature 1 has a drawback in that the fly ash needs to be replaced or reloaded when the phosphoric acid removal capacity of the fly ash reaches saturation, and this task requires significant labor and cost.

Water clarification methods using plants are also attracting attention as technologies for clarifying rivers, lakes, marshes, and other water bodies where domestic wastewater and the like flow in. Patent Literature 2 proposes such a water clarification method, wherein water is clarified by a biogeofilter (BGF) channel, which uses a combination of useful plants and natural mineral filter media.

The water clarification method disclosed in Patent Literature 2 includes a channel divided into a most upstream receiving water body and three sectioned water bodies (an upstream water body, an intermediate water body, and a downstream water body) that progressively become deeper from the upstream to the downstream side, wherein each of the sectioned water bodies is filled with natural mineral filter media, where a plurality of useful plants are planted, wherein each of the plurality of useful plants has a different growth period and has hairy roots that thrive to a length corresponding to a water depth of each sectioned water body, so as to clarify the water. Thus, a channel with a total length of about 15 to 20 m is required to carry out the water clarification method disclosed in Patent Literature 2, which poses the drawback of requiring a clarification apparatus with a large horizontal area.

Therefore, there is a need for the development of a method for water clarification and greening that can simply and efficiently remove nitrogen and phosphorus in a smaller horizontal area than in conventional methods.

### CITATION LIST

### Patent Literature

Patent Literature 1: JP 4900613 B
Patent Literature 2: JP 3787610 B

### SUMMARY OF INVENTION

### Technical Problem

It is an object of the present invention to provide a method and an apparatus for water clarification and greening that can simply and efficiently adsorb and remove nitrogen and/or phosphorus in a smaller horizontal area than in conventional methods, that is, exhibit improved water clarification performance per unit area.

It is also an object of the present invention to provide a method and an apparatus for water clarification and greening that can stably adsorb and remove nitrogen and/or phosphorus not only in summer but also in winter.

### Solution to Problem

As a result of extensive research to solve the foregoing problem, the present inventors have found that it is possible to efficiently remove nitrogen and/or phosphorus in a biogeofilter (BGF) channel that combines plants with specific filter media, by using a granular material containing incineration ash as the filter media, such that nitrogen and/or phosphorus in the water to be treated can be adsorbed onto the surface of the granular material containing incineration ash, and the nitrogen and/or phosphorus is used for plant growth. The present invention has been completed as a result of further research based on these findings.

In summary, the present invention is as itemized below:

### Item 1.

A method for water clarification and greening, which simultaneously achieves water clarification and greening by planting a plant in a channel:
wherein water flowing into the channel contains ammonia nitrogen and/or phosphorus;
the channel comprises a planting portion where the plant is planted in a filtration bed filled with a granular material containing incineration ash; and
the granular material containing incineration ash adsorbs the ammonia nitrogen and/or phosphorus in the water flowing into the channel, and the plant grows by absorbing the ammonia nitrogen and/or phosphorus adsorbed onto the granular material containing incineration ash, so as to achieve water clarification and greening.

### Item 2.

The method according to item 1, wherein the water containing ammonia nitrogen and/or phosphorus is wastewater from a septic tank.

### Item 3.

The method according to item 1 or 2, wherein the granular material containing incineration ash releases a fertilizer component containing at least one metal ion selected from the group consisting of an alkali metal ion, a calcium ion, and a magnesium ion.

### Item 4.

The method according to any one of items 1 to 3, wherein the phosphorus adsorbed onto the granular material containing incineration ash is soluble in citric acid.

### Item 5.

The method according to any one of items 1 to 4, wherein the water flowing into the channel further contains a sulfuric acid salt, and, when hydrogen sulfide is produced from the sulfuric acid salt, the method can remove the hydrogen sulfide.

### Item 6.

The method according to any one of items 1 to 5, wherein the method can adjust the pH in a neutral to weakly alkaline range.

### Item 7.

The method according to any one of items 1 to 6, wherein the granular material containing incineration ash is a granulated material containing coal ash and cement.

### Item 8.

The method according to any one of items 1 to 7, wherein the method can adjust an amount of adsorption of the ammonia nitrogen and/or phosphorus.

### Item 9.

A fertilizer composition comprising the granular material containing incineration ash after use in the method according to any one of items 1 to 8.

### Item 10.

An apparatus for water clarification and greening, which simultaneously achieves water clarification and greening by planting a plant in a channel;
wherein water flowing into the channel contains ammonia nitrogen and/or phosphorus;
the channel comprises a planting portion where the plant is planted in a filtration bed filled with a granular material containing incineration ash; and
the granular material containing incineration ash adsorbs the ammonia nitrogen and/or phosphorus in the water flowing into the channel, and the plant grows by absorbing the ammonia nitrogen and/or phosphorus adsorbed onto the granular material containing incineration ash, so as to achieve water clarification and greening.

### Item 11.

The apparatus according to item 10, wherein the channel comprises three sections, which are an upstream section, a middle section, and a downstream section, from the upstream side; and
the middle section comprises the planting portion.

### Item 12.

The apparatus according to item 11, wherein the upstream section comprises an inlet on an upstream side surface, and allows wastewater from a septic tank to flow into the upstream section through the inlet and allows suspended solids in the wastewater to settle and be removed;
the middle section is the planting portion where the plant is planted in the filtration bed filled with the granular material containing incineration ash, wherein the granular material containing incineration ash adsorbs the ammonia nitrogen and/or phosphorus in the wastewater that has passed the upstream section, and the plant grows by absorbing the ammonia nitrogen and/or phosphorus adsorbed onto the granular material containing incineration ash; and
the downstream section comprises an outlet on a downstream side surface, and allows suspended solids in the wastewater that has passed the middle section to settle and be removed and allows treated water to be discharged through the outlet.

### Item 13.

The apparatus according to any one of items 10 to 12, wherein the water containing ammonia nitrogen and/or phosphorus is wastewater from a septic tank.

### Item 14.

The apparatus according to any one of items 10 to 13, wherein the granular material containing incineration ash releases a fertilizer component containing at least one metal ion selected from the group consisting of an alkali metal ion, a calcium ion, and a magnesium ion.

### Item 15.

The apparatus according to any one of items 10 to 14, wherein the phosphorus adsorbed onto the granular material containing incineration ash is soluble in citric acid.

### Item 16.

The apparatus according to any one of items 10 to 15, wherein the apparatus can remove hydrogen sulfide contained in the water flowing into the channel.

### Item 17.

The apparatus according to any one of items 10 to 16, wherein the apparatus can adjust the pH to 5.8 or more and 8.6 or less.

### Item 18.

The apparatus according to any one of items 10 to 17, wherein the granular material containing incineration ash is a granulated material containing coal ash and cement.

### Item 19.

The apparatus according to any one of items 10 to 18, wherein the apparatus can adjust an amount of adsorption of the ammonia nitrogen and/or phosphorus, and can adjust an amount of release of the fertilizer component containing at least one metal ion selected from the group consisting of an alkali metal ion, a calcium ion, and a magnesium ion.

At present, it is impossible or impractically difficult to completely specify the structure of or the whole range of components contained in the fertilizer composition as specified in the method among the aspects of the present invention, and therefore, the fertilizer composition is specified in the product-by-process claim.

### Advantageous Effects of Invention

According to the present invention, it is possible to provide a method for water clarification and greening that can simply and efficiently remove nitrogen and/or phosphorus in a smaller horizontal area than in conventional methods, that is, exhibits improved water clarification performance per unit area.

According to the present invention, it is also possible to provide a method for water clarification and greening that can stably remove nitrogen and/or phosphorus not only in summer but also in winter.

### BRIEF DESCRIPTION OF DRAWINGS

FIG. 1 is a schematic diagram showing one example of the apparatus for water clarification and greening of the present invention.

FIG. 2 is a graph showing changes in the concentrations of nitrogen-containing ions in wastewater with added granulated coal ash.

FIG. 3 is a graph illustrating changes in the equivalents of cations in wastewater with added granulated coal ash, during 15 minutes after the beginning of the test.

FIG. 4 is a graph showing the results of a citric acid solubility evaluation test for granulated coal ash before and after phosphorus adsorption, and for pumice before and after phosphorus adsorption.

FIG. 5 is a graph showing the results of a removal test for hydrogen sulfide in wastewater using granulated coal ash.

FIG. 6 is a schematic view illustrating the placement of apparatus 5 (filter media: granulated coal ash: without plants), apparatus 6 (filter media: pumice; without plants), and the wastewater storage tank.

FIG. 7 is a graph showing pH changes in influent water, effluent water from apparatus 5 (filter media: granulated coal ash: without plants), and effluent water from apparatus 6 (filter media: pumice; without plants).

FIG. 8 is a graph showing changes in ammonia nitrogen (NH₄—N) concentration in winter, for influent water, effluent water from apparatus 2 (filter media: granulated coal ash: plants: flowering plants), and effluent water from apparatus 4 (filter media: pumice: plants: flowering plants).

FIG. 9 is a graph showing period average values of the ammonia nitrogen (NH₄—N) concentration in winter, for influent water, effluent water from apparatus 2 (filter media: granulated coal ash: plants: flowering plants), and effluent water from apparatus 4 (filter media: pumice: plants: flowering plants).

FIG. 10 is a graph showing changes in total phosphorus (T-P) concentration in winter, for influent water, effluent water from apparatus 2 (filter media: granulated coal ash: plants: flowering plants), and effluent water from apparatus 4 (filter media: pumice: plants: flowering plants).

FIG. 11 is a graph showing period average values of the total phosphorus (T-P) concentration in winter, for influent water, effluent water from apparatus 2 (filter media: granulated coal ash: plants: flowering plants), and effluent water from apparatus 4 (filter media: pumice: plants: flowering plants).

FIG. 12 is a graph showing changes in ammonia nitrogen (NH₄—N) concentration in summer, for influent water, effluent water from apparatus 1 (filter media: granulated coal ash: plants: feed crops), effluent water from apparatus 2 (filter media: granulated coal ash: plants: flowering plants), and effluent water from apparatus 4 (filter media: pumice: plants: flowering plants).

FIG. 13 is a graph showing period average values of the ammonia nitrogen (NH₄—N) concentration in summer, for influent water, effluent water from apparatus 1 (filter media: granulated coal ash: plants: feed crops), effluent water from apparatus 2 (filter media: granulated coal ash: plants: flowering plants), and effluent water from apparatus 4 (filter media: pumice; plants: flowering plants).

FIG. 14 is a graph showing changes in total phosphorus (T-P) concentration in summer, for influent water, effluent water from apparatus 1 (filter media: granulated coal ash: plants: feed crops), effluent water from apparatus 2 (filter media: granulated coal ash: plants: flowering plants), and effluent water from apparatus 4 (filter media: pumice: plants: flowering plants).

FIG. 15 is a graph showing period average values of the total phosphorus (T-P) concentration in summer, for influent water, effluent water from apparatus 1 (filter media: granulated coal ash: plants: feed crops), effluent water from apparatus 2 (filter media: granulated coal ash: plants: flowering plants), and effluent water from apparatus 4 (filter media: pumice: plants: flowering plants).

FIG. 16A shows a photograph after the test was performed during the period from Dec. 24, 2020 to Mar. 4, 2021, using apparatus 1 (filter media: granulated coal ash: plants: feed crops); and FIG. 16B shows a photograph after the test was performed during the period from Dec. 24, 2020 to Mar. 4, 2021, using apparatus 3 (filter media: pumice: plants: feed crops).

### DESCRIPTION OF EMBODIMENTS

### Method for Water Clarification and Greening

A method for water clarification and greening of the present invention performs water clarification and greening using an apparatus for water clarification and greening.

The apparatus for water clarification and greening may be, for example, a biogeofilter channel that combines plants with filter media.

As used herein, the term “apparatus” is interchangeable with “system”. The term “water clarification and greening” not only includes the concept of water clarification and greening, but also the concept of water clarification or greening.

### Apparatus for Water Clarification and Greening

The apparatus for water clarification and greening may be, for example, a biogeofilter channel 1 as shown in FIG. 1.

The biogeofilter channel 1 is formed of a culture tank 4 including, for example, a filtration bed (geofilter) filled with filter media 2 and plants 3 planted in the filtration bed.

The culture tank 4 is divided into three sections (an upstream section 6, a middle section 7, and a downstream section 8), for example, by perforated plates 5.

Each of the perforated plates 5 to be used herein is not specifically limited as long as it is a plate-like material with a plurality of holes of a size allowing water flowing into the channel, such as wastewater from a septic tank, to pass through, but not allowing the filter media to pass through.

Examples of such perforated plates include 3 mm thick polyvinyl chloride plates with 5 mm diameter holes formed at 10 mm intervals.

The culture tank 4 preferably includes at least two or more perforated plates 5. When the culture tank 4 includes, for example, two perforated plates 5, the culture tank 4 is divided into three sections (the upstream section 6, middle section 7, and downstream section 8).

When the culture tank 4 includes three perforated plates 5, the culture tank 4 is divided into four sections. The structure of the culture tank 4 with four sections may be any of the following:
(1) [two upstream sections]/[one middle section]/[one downstream section] from the upstream side;
(2) [one upstream section]/[two middle sections]/[one downstream section] from the upstream side: or
(3) [one upstream section]/[one middle section]/[two downstream sections] from the upstream side.

With the structure (1), the four sections of the culture tank 4 may be, for example, [upstream section 6-1]/[upstream section 6-2]/[middle section 7 that functions as a planting portion]/[downstream section 8] from the upstream side.

With the structure (2), the four sections of the culture tank 4 may be, for example, [upstream section 6]/[middle section 7-1 that functions as a planting portion]/[middle section 7-2 that functions as a planting portion]/[downstream section 8] from the upstream side.

With the structure (3), the four sections of the culture tank 4 may be, for example, [upstream section 6]/[middle section 7 that functions as a planting portion]/[downstream section 8-1]/[downstream section 8-2] from the upstream side.

### Upstream Section

Water flowing into the channel (hereinafter also referred to as “water to be treated”) flows into the upstream section 6 of the culture tank 4, through an inlet 9 formed on an upstream side surface of the upstream section 6 of the culture tank 4. Suspended solids (SS) in the water to be treated settle and are removed in the upstream section 6. The inlet 9 is preferably formed at a height where it is not submerged even if the perforated plate 5 becomes clogged and the water level in the water to be treated rises. With the structure (1) of four sections, which has two upstream sections, these two upstream sections serve to block matter such as solids and suspended solids contained in the water flowing into the channel, for example, wastewater from a septic tank, to prevent clogging of the perforated plates, filter media, and the like.

The water to be treated is further diluted as required and then fed into the middle section 7. The total nitrogen content and total phosphorus content in the water to be treated for feeding into the middle section 7 are not specifically limited. Examples of the total nitrogen content include the range of about 2 to 80 mg/L. Examples of the total phosphorus content include the range of about 0.5 to 10 mg/L.

### Middle Section

In the middle section 7, a filtration bed is formed by filling the middle section 7 with the filter media, where the plants 3 are planted. Thus, the middle section 7 functions as a planting portion. The middle section 7 may be a single section or may be divided into two or more sections by the perforated plate 5. With the structure (2) of four sections, which has a perforated plate between the middle section 7-1 and the middle section 7-2, the perforated plate, as a part of the planting portion, serves to prevent the filter media from being displaced by the wastewater; and serves to stabilize the height of the filter media over a long term.

When the water to be treated is fed into the middle section 7, the filter media 2 filling the middle section 7 adsorb nitrogen, phosphorus, and the like dissolved in the water to be treated. Furthermore, the plants 3 planted in the filtration bed grow by absorbing nitrogen, phosphorus, and the like contained in the water to be treated and/or adsorbed on the filter media 2. This effectively removes the nitrogen and phosphorus from the water to be treated.

The water to be treated is then fed into the downstream section 8, which also allows suspended solids (SS) to settle.

### Downstream Section

The water treated in the middle section 7 flows into the downstream section 8 and is then discharged through an outlet 10, which is formed near the water surface on a downstream side surface of the downstream section 8. With the structure (3) of four sections, which has two downstream sections 8, these two downstream sections serve to block the filter media with a reduced particle diameter due to collapse of the filter media after year-round cultivation, to prevent clogging, for example, of the outlet of the culture tank.

The apparatus for water clarification and greening of the present invention includes one or more planting portions where plants are planted in the filter media of the filtration bed. The number of planting portions may be set appropriately according to, for example, the amount of the water to be treated fed into the apparatus for water clarification and greening, and the amount of pollutants (such as nitrogen and phosphorus) contained in the water to be treated.

To increase the number of planting portions, the number of middle sections with planting portions may be increased, as in the structure (2) of four sections. In an alternative method, the above-mentioned culture tanks may be connected to increase the number of planting portions. For example, to increase the number of planting portions to two by connecting culture tanks, two culture tanks may arranged to connect the outlet of an upstream installed culture tank (upstream culture tank) and the inlet of a downstream installed culture tank (downstream culture tank), such that the wastewater fed through the inlet (upstream inlet) of the upstream culture tank passes through the upstream culture tank to flow through the outlet (upstream outlet) of the upstream culture tank into the inlet of the downstream culture tank, and then passes through the downstream culture tank to be discharged through the outlet (downstream outlet) of the downstream culture tank.

### Filter Media

In the method for water clarification and greening of the present invention, the filter media may be any granular material containing incineration ash.

The incineration ash is not specifically limited as long as it includes silica (SiO₂) and alumina (Al₂O₃) as its components. Examples of the incineration ash include waste incineration ash of municipal waste, wood chips, tire chips, paper sludge, sewage sludge, or biomass; and incineration ash of coal, refuse derived fuel, refuse paper and plastic fuel, and the like. These types of incineration ash may be used alone or as a mixture of two or more.

The incineration ash is preferably incineration ash of coal (coal ash). Because of its low content of impurities such as arsenic, incineration ash of coal (coal ash) generated at electric power companies is particularly preferred as a raw material of the filter media used in the present invention.

The granular material containing incineration ash is preferably granulated coal ash (GCA). The granulated coal ash contains coal ash, a solidifying material, and a water retaining material. The granulated coal ash is obtained by granulating coal ash. Granulation is performed by mixing coal ash with a solidifying material and water. Because coal ash has poor water retention, a water retaining material is preferably added to the solidifying material and water during granulation. The granulated coal ash is obtained by introducing these materials into a mixer, and stirring and mixing them at around room temperature.

The coal ash may be incineration ash of coal generated at electric power companies. The coal ash may be so-called fly ash discharged from thermal power plants using coal as fuel. Silica (SiO₂) and alumina (Al₂O₃) are the main components of fly ash, with these two components constituting 70 to 90% of the whole. Fly ash contains oxides such as Fe₂O₃, CaO, MgO, SO₃, Na₂O, K₂O, and MnO as other components. Fly ash is generated in large amounts during combustion of coal, and its recycling is desired. Thus, fly ash is useful as a raw material of the filter media used in the method for water clarification and greening of the present invention.

The solidifying material may be, for example, cement. The cement is not limited to specific types. Examples of types of cement include common cement used in concrete production, such as Portland cement and alumina cement. From the viewpoint of environmental sustainability, it is preferred to use cement that does not leach toxic components into waters such as the ocean, lakes, marshes, and the like. Examples of cement with low leaching of toxic components include blast furnace cement (particularly, blast furnace cement B class). It is preferred not to use Portland cement called ordinary cement, which leaches large amounts of toxic components such as hexavalent chromium. A combination of cement and gypsum dihydrate (calcium sulfate dihydrate) may also be used.

The water retaining material may be, for example, bentonite or clayey soil. Examples of clayey soil include marine or freshwater dredged clays and Kasaoka clay. Of these, bentonite is preferred as the water retaining material.

The proportion of the coal ash is preferably 70 parts by mass or more and 97 parts by mass or less, more preferably 80 parts by mass or more and 95 parts by mass or less, and even more preferably 85 parts by mass or more and 93 parts by mass or less. Blending the coal ash in the above-defined ranges facilitates handling of the granulated material and provides the granulated material with sufficient strength.

The proportion of the solidifying material is preferably 2 parts by mass or more and 30 parts by mass or less, more preferably 7 parts by mass or more and 20 parts by mass or less, and even more preferably 10 parts by mass or more and 15 parts by mass or less. Blending the solidifying material in the above-defined ranges facilitates handling of the granulated material while providing a strength required in the material. When gypsum dihydrate is incorporated into the solidifying material, gypsum dihydrate is preferably blended in a proportion of 7 parts by mass or more and 10 parts by mass or less.

When the water retaining material is added, the proportion is preferably 5 parts by mass or less, more preferably 4 parts by mass or less, and even more preferably 2 parts by mass or more and 3 parts by mass or less. Blending the water retaining material in the above-defined ranges makes troublesome adhesion during granulation less likely to occur, and facilitates handling. While granulation is possible without a water retaining material, the addition of a water retaining material achieves more stable granulation.

During granulation, the above-mentioned materials are mixed with water. Examples of water that can be used include tap water, distilled water, ion exchange water, seawater, brackish water, ground water, river water, aqueous sodium chloride solution, and aqueous lithium nitrite solution. The amount of water may be adjusted such that stable granulation is achieved, and the strength of particles falls in a required range. For example, water can be added in an amount of 15 parts by mass or more and 25 parts by mass or less, preferably 18 parts by mass or more and 25 parts by mass or less.

The granulated coal ash may also contain components other than those mentioned above. Examples of other components include lanthanum and iron. The addition of lanthanum can further improve the phosphorus adsorption capacity.

The granulated coal ash can be obtained by stirring and mixing the above-mentioned materials, and granulating the mixture. The device to be used is not specifically limited as long as it can perform stirring and mixing, for example, a mixer. Examples of the mixer include a high-speed rotary mixer having a horizontal cylindrical drum, a stirring blade mounted on a rotary main shaft mounted in the center of the drum, and an independently driven chopper mounted on an inside side surface of the drum. Examples of operating conditions using this mixer include operating the mixer for about 3 to 10 minutes by rotating the stirring blade at about 50 to 100 rpm, and simultaneously rotating the chopper at a high speed of about 1000 to 2000 rpm. This gives a homogeneous granulated material with an average particle diameter of 2 to 10 mm in a short time.

Examples of the mixer other than that mentioned above include a mixer having a vertical mixing tank with a bottom surface and a funnel-shaped inclined side surface that descends toward an outlet formed in the center of the bottom surface: a high-speed rotary shaft and low-speed rotary shafts that are disposed concentrically, wherein the high-speed rotary shaft is mounted with a spiral-shaped inner kneading blade that rotates in the center of the mixing tank, in a vertical downward direction in the center of the mixing tank, and the low-speed rotary shafts are mounted with outer kneading blades via arms such that the outer kneading blades rotate in close proximity to an inside side surface of the mixing tank; and a drive unit that drives the high-speed and low-speed rotary shafts to rotate in reverse directions.

A granulated material with a particle size distribution suitable for the conditions can be obtained using these mixers. A specific method for producing the granulated material is as follows: Granulation is performed after adjusting the operating conditions of the mixer to obtain a desired particle size distribution. Then, the granulated material is taken out from the mixer, and water is sprayed on the granulated material about once a day for about a week. The granulated material is then dried for a certain time to give a desired granulated material. The drying temperature is preferably 5° C. or more, more preferably 10° C. or more and 40° C. or less, and even more preferably 15° C. or more and 25° C. or less. The drying period may be selected appropriately from a period of about 1 day to 6 months, according to conditions such as the solidifying material used and drying temperature. The granulated material is rendered porous by drying.

The resulting granulated coal ash is particulate, and can be used as is, as the filter media. The particle diameter of the granulated coal ash is not limited and may be set appropriately according to the application, conditions of use, and the like. The average particle diameter of the granulated coal ash may be, for example, about 1 to 30 mm. In the method for water clarification and greening of the present invention, two types of the granulated coal ash with different average particle diameters are preferably used as the filter media. For example, the granulated coal ash with an average particle diameter of 10 mm or more and 20 mm or less and the granulated coal ash with a smaller particle diameter (with an average particle diameter of 5 mm or more and less than 10 mm) may be used. The particle size can be adjusted using, for example, known methods such as sizing and milling. The particle shape of the granulated coal ash is also not limited, and the granulated coal ash may be in any form such as a spherical, flake, or irregular shape. In particular, from the viewpoint of the ease of filling a fixed bed with the granulated coal ash, the ease of distributing liquid, and the like, the particle shape of the granulated coal ash is preferably spherical.

The resulting granulated material may be further calcined. Calcining the granulated material strengthens the bond between the coal ash, solidifying material, and water retaining material. From the viewpoint of, for example, the strength of the granulated material after calcining, the calcination temperature is preferably 500 to 1000° C., more preferably 600 to 1000° C., and even more preferably 600 to 800° C. The calcination atmosphere is not specifically limited and may be, for example, any atmosphere such as an oxidizing atmosphere (air), a reducing atmosphere, or an inert gas atmosphere. The calcination time may also be adjusted appropriately according to the calcination temperature and the like. The sintered body obtained by calcination is particulate and can be used as is. The sintered body may be subjected to treatment such as milling or sizing, as required, before use.

In the method for water clarification and greening of the present invention, the filter media are the granular material containing incineration ash. When the granular material containing incineration ash is granulated coal ash, the granulated coal ash has a crush strength of 1.2 or more (test method: JIS-Z-8841). This prevents the granulated coal ash from breaking into pieces during use, which may cause clogging. The granulated coal ash typically has a dry density of 0.8 to 1.1, preferably 1.0 to 1.1 (test method: JIS-A-1225). Thus, even if the water level of the wastewater rises, the granulated coal ash does not float, and only water is discharged.

Two types of the granulated coal ash with different average particle diameters are preferably used. For example, the granulated coal ash with an average particle diameter of 10 mm or more and 20 mm or less may be used in a portion where water passes through, below the water surface. On the other hand, the granulated coal ash with an average particle diameter smaller than that of the above-mentioned granulated coal ash, that is, with an average particle diameter of 5 mm or more and less than 10 mm, may be used above the water surface. By placing the filter media with a smaller particle diameter above the water surface, plant seeds are prevented from dropping into the water when sown.

The granular material containing incineration ash has high nitrogen and phosphorus adsorption capacities. Additionally, phosphorus adsorbed on the granular material containing incineration ash is adsorbed in the same form (citric acid-soluble) as that in slow-release fertilizers and thus, is not leached out by rain and the like, and can be effectively used by plants to contribute to improved growth. Thus, nitrogen and phosphorus can be efficiently removed using an apparatus with a small horizontal area. Moreover, the granular material containing incineration ash can release a fertilizer component containing at least one metal ion selected from the group consisting of an alkali metal ion (such as a sodium or potassium ion), a calcium ion, and a magnesium ion. Furthermore, the granular material containing incineration ash has a hydrogen sulfide adsorption capacity, and septic tank wastewater contains a sulfuric acid salt. When hydrogen sulfide, which is harmful to plants, is produced from the sulfuric acid salt, the granular material containing incineration ash can adsorb and remove the hydrogen sulfide to maintain good plant growth.

### Plants

Plants are planted in the filtration bed. The plants are not limited to specific types as long as they are cultivated with fertilizers, including edible and inedible agricultural crops. Examples of types of the plants include terrestrial plants and aquatic plants.

Examples of terrestrial plants include feed crops, flowering plants, and conifers. Examples of feed crops include rye, leaf mustard, sunflower, and sorgo. Examples of flowering plants include calendula, garden cyclamen, primula julienne, pansy, viola, ornamental cabbage, dusty miller, tulip, torenia, ivy, zinnia profusion, Zinnia linealis, Madagascar periwinkle, SunPatiens, sedum, French marigold, corylus, portulaca, calibrachoa, celosia, and kochia. Examples of conifers include Thuja orientalis. Feed crops and flowering plants are preferred as terrestrial plants, with feed crops being more preferred, which grow well even in winter when the temperature is low.

Examples of aquatic plants include common water hyacinth, papyrus, reeds, JIris ensata var. ensata, rice plant, Juncus decipiens, Sagittaria trifolia var. edulis, and taro (Colocasia esculenta).

These plants may be used alone or in combinations of two or more.

The following describes the method for water clarification and greening using the apparatus for water clarification and greening with the structure described above, and the operation of the apparatus for water clarification and greening.

When the water to be treated, such as secondary treated water of domestic wastewater from a combined treatment septic tank or groundwater, flows through the inlet into the uppermost upstream section of the culture tank, suspended solids (SS) in the water to be treated settle and are stored. The stored suspended solids (SS) are discharged and removed in a timely manner.

Suspended solids (SS) in the influent water, passed through the upstream section, are filtered through a perforated plate on their way to the middle section. Thus, suspended solids (SS) settled at the bottom of the upstream section do not flow into the subsequent middle section, which can prevent clogging of the filter media with suspended solids (SS) in the middle section.

The middle section is filled with the granular material containing incineration ash as the filter media. The particle diameter of the granular material may vary depending on the type of plants to be planted. When the plants are seedlings, filter media with a particle diameter of about 10 to 20 mm may be used. The particle diameter as large as about 10 to 20 mm of the filter media also reduces clogging of the filter media.

When plants are grown from seeds, it is preferred to fill the region of the middle section below the water surface with the filter media having a larger particle diameter (a particle diameter of 10 to 20 mm) and fill the region of the middle section above the water surface with the filter media having a smaller particle diameter (a particle diameter of 5 to 10 mm). Reducing the particle diameter of the filter media to be filled in the region above the water surface can prevent sowed seeds from dropping into water and flowing away. The filter media filled in the region below the water surface efficiently adsorb nitrogen and phosphorus in the water to be treated.

Then, the roots of the plants planted in the filter media of the region above the water surface grow to the filter media of the region below the water surface. The roots absorb nitrogen and phosphorus in the water to be treated and also absorb nitrogen and phosphorus adsorbed on the filter media, which promotes the plant growth.

The water to be treated, passed through the middle section, is subjected to solid-liquid separation through a perforated plate on its way to the downstream section, and furthermore, suspended solids (SS) in the water to be treated settle and are removed in the downstream section, and the clarified water having nitrogen and/or phosphorus removed therefrom is discharged through the outlet formed on the downstream side surface.

Using the method for water clarification and greening described above, the pH can be adjusted in a neutral to weakly alkaline range (in a pH range of about 6 to 11) not only in summer but also in winter, that is, throughout the year (all year round). The term “neutral” refers to a pH range of 6 to 8, and the term “weakly alkaline” refers to a pH of more than 8 and 11 or less.

Moreover, using the method for water clarification and greening described above, the amount of adsorption of ammonia nitrogen and/or phosphorus can be adjusted not only in summer but also in winter, that is, throughout the year.

Furthermore, the granular material containing incineration ash after use in the method for water clarification and greening can be used as, for example, a fertilizer composition or a soil conditioner.

### EXAMPLES

The present invention will be hereinafter described in more detail with examples and the like; however, the technical scope of the invention is not limited thereto.

### Test Example 1 (Evaluation of Performance of Granular Material Containing Incineration Ash)

The performance of a granular material containing incineration ash used in the apparatus for water clarification and greening was evaluated. Granulated coal ash (Hi-Beads (registered trademark) manufactured by Chugoku Electric Power Co.) was used herein as the granular material containing incineration ash.

### (Test Example 1-1) Measurement of Changes in Nitrogen and Cation Concentrations in Wastewater

Experimental tank 1 was prepared, which was a container with a stirring function and an aeration function, containing actual septic tank wastewater (20 L) and the granulated coal ash (20 L). To experimental tank 1, 1.5 g of ammonium chloride was added to achieve an NH₄—N concentration of about 20 mg/L. One minute after the addition was defined as zero minute, and the water was sampled with aeration at 1, 2, 3, 5, 10, 15, 20, 25, 30, 45, 60, 90, 120, 150, 180, and 240 minutes.

Each of the water samples was filtered through a membrane filter with a pore diameter of 0.45 μm, and then analyzed for nitrogen and cation concentrations using an HPLC apparatus (Prominence manufactured by Shimadzu Corporation).

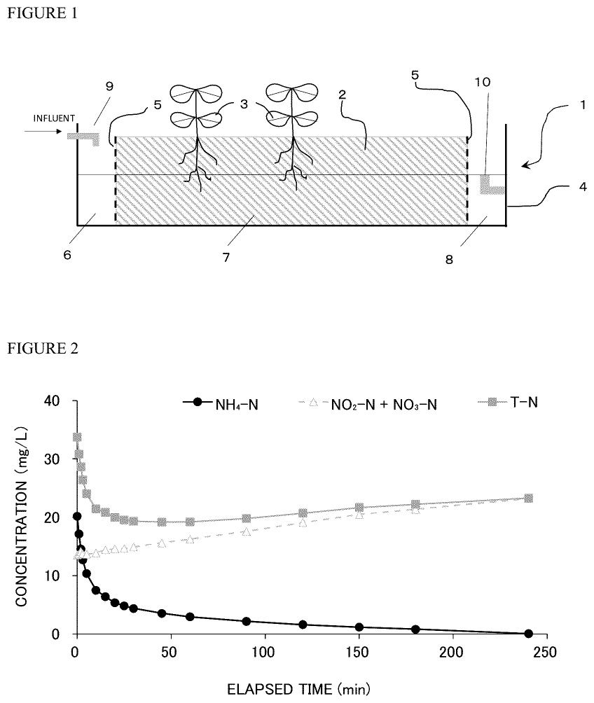

The measured nitrogen concentrations were ammonia nitrogen (NH₄—N), nitrite nitrogen (NO₂—N), nitrate nitrogen (NO₃—N), the sum of nitrite nitrogen and nitrate nitrogen (NO₂-N+NO₃—N), and total nitrogen (T-N). Changes in these nitrogen concentrations are shown in Table 1 and FIG. 2. The sum of nitrite nitrogen and nitrate nitrogen (NO₂-N+NO₃—N) is equal to the nitrogen oxide (NOx-N) concentration.

TABLE 1

| | Nitrogen Concentrations [mg/L] | | | | |
|---|---|---|---|---|---|
| Time | | | | NO₂—N + | |
| (min) | NH₄—N | NO₂—N | NO₃—N | NO₃—N | T-N |
| 0 | 20.2 | 0.0 | 13.5 | 13.5 | 33.7 |
| 1 | 17.1 | 0.0 | 13.7 | 13.7 | 30.8 |
| 2 | 14.6 | 0.0 | 14.1 | 14.1 | 28.7 |
| 3 | 12.7 | 0.0 | 13.7 | 13.7 | 26.4 |
| 5 | 10.4 | 0.0 | 13.7 | 13.7 | 24.0 |
| 10 | 7.5 | 0.0 | 13.9 | 13.9 | 21.5 |
| 15 | 6.4 | 0.0 | 14.4 | 14.4 | 20.8 |
| 20 | 5.4 | 0.0 | 14.6 | 14.6 | 20.0 |
| 25 | 4.8 | 0.0 | 14.7 | 14.7 | 19.5 |
| 30 | 4.4 | 0.1 | 14.9 | 14.9 | 19.3 |
| 45 | 3.5 | 0.1 | 15.6 | 15.6 | 19.2 |
| 60 | 2.9 | 0.1 | 16.2 | 16.3 | 19.2 |
| 90 | 2.2 | 0.1 | 17.5 | 17.6 | 19.8 |
| 120 | 1.6 | 0.0 | 19.1 | 19.1 | 20.7 |
| 150 | 1.2 | 0.0 | 20.5 | 20.5 | 21.7 |
| 180 | 0.8 | 0.2 | 21.1 | 21.4 | 22.2 |
| 240 | 0.1 | 0.2 | 23.0 | 23.2 | 23.3 |

### <Results>

Table 1 and FIG. 2 show that the ammonia nitrogen (NH₄—N) concentration significantly decreased within 15 minutes after the beginning of the test.

On the other hand, the NOx-N concentration (NO₂-N+NO₃—N) was found to increase at generally the same rate throughout the test period. This suggests that biological nitrification, that is, the conversion of NH₄—N (ammonia nitrogen) to NOx-N (nitrogen oxides), was taking place.

The measured cation concentrations were ammonium ion (NH₄⁺), sodium ion (Na⁺), potassium ion (K⁺), magnesium ion (Mg²⁺), and calcium ion (Ca²⁺) concentrations. Changes in these ion concentrations are shown in Table 2.

TABLE 2

| | |
|---|---|
| Time | Cation Concentrations [mg/L] |

| (min) | NH₄⁺ | Li⁺ | Na⁺ | K⁺ | Mg²⁺ | Ca²⁺ |
|---|---|---|---|---|---|---|
| 0 | 26.0 | 0.0 | 44.9 | 12.5 | 3.1 | 32.5 |
| 1 | 22.1 | 0.0 | 46.4 | 13.4 | 3.5 | 34.0 |
| 2 | 18.7 | 0.0 | 46.6 | 13.9 | 3.5 | 34.6 |
| 3 | 16.4 | 0.0 | 47.0 | 14.4 | 3.7 | 35.1 |
| 5 | 13.3 | 0.0 | 47.5 | 15.1 | 3.7 | 36.4 |
| 10 | 9.7 | 0.0 | 48.5 | 16.2 | 3.9 | 38.0 |
| 15 | 8.2 | 0.0 | 49.0 | 16.6 | 4.0 | 39.0 |
| 20 | 6.9 | 0.0 | 49.2 | 16.8 | 4.0 | 39.1 |
| 25 | 6.2 | 0.0 | 49.6 | 16.9 | 4.0 | 39.1 |
| 30 | 5.7 | 0.0 | 49.5 | 16.8 | 4.1 | 39.4 |
| 45 | 4.6 | 0.0 | 49.7 | 16.7 | 4.1 | 39.8 |
| 60 | 3.8 | 0.0 | 49.8 | 16.4 | 4.1 | 39.8 |
| 90 | 2.8 | 0.0 | 49.7 | 15.9 | 4.1 | 39.8 |
| 120 | 2.1 | 0.0 | 49.7 | 15.4 | 4.1 | 39.6 |
| 150 | 1.5 | 0.0 | 49.7 | 15.0 | 4.1 | 39.8 |
| 180 | 1.1 | 0.0 | 49.5 | 14.5 | 4.1 | 39.6 |
| 240 | 0.1 | 0.0 | 49.4 | 13.8 | 4.0 | 40.0 |

Table 2 shows that, during 15 minutes after the beginning of the test, the ammonium ion (NH₄⁺) concentration decreased, while the concentrations of other cations (Na⁺, K⁺, Mg²⁺, and Ca²⁺) increased. Lithium ion (Li⁺) was not detected.

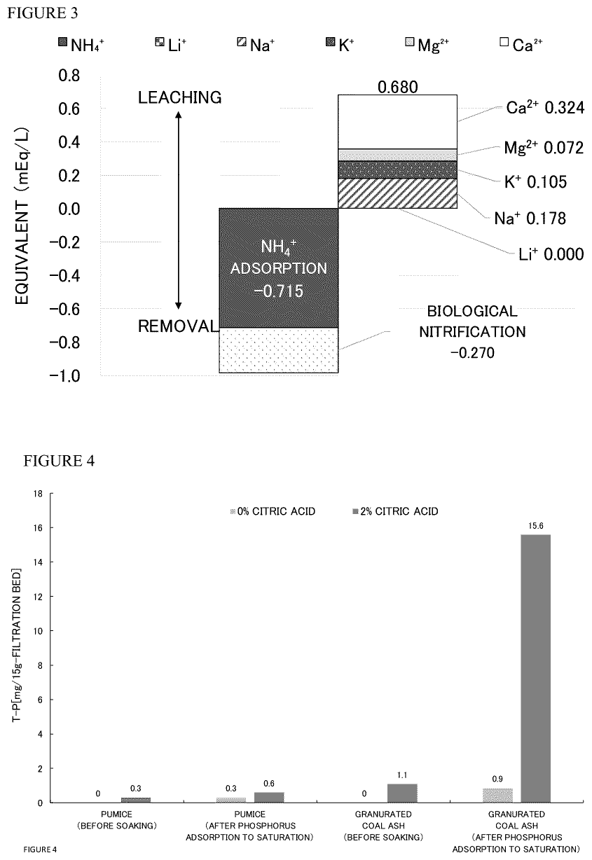

Changes in equivalent (mEq/L) were calculated from the changes in concentration (mg/L) during 15 minutes after the beginning of the test shown in Tables 1 and 2. The results are shown in Table 3 and FIG. 3.

TABLE 3

| | | | | | | | NH₄⁺ |
|---|---|---|---|---|---|---|---|
| | | | | NO₂—N + | Biological | | Excluding |
| Nitrogen | NH₄—N | NO₂—N | NO₃—N | NO₃—N | Nitrification | NH₄⁺ | Nitrified |
| Changes in Concentration | −13.8 | 0.0 | 0.9 | 0.9 | −12.9 | −17.8 | −12.9 |
| [mg/L] over 0-15 min | | | | | | | |
| Changes in Mole [mmol/L] | −0.985 | 0.004 | 0.061 | 0.064 | −0.27 | −0.985 | −0.715 |
| over 0-15 min | | | | | | | |
| Changes in Equivalent | — | — | — | — | — | −0.985 | −0.715 |
| [mEq/L] over 0-15 min | | | | | | | |

| Alkali Metal Ion, Calcium | | | | | | Li⁺Na⁺K⁺ |
|---|---|---|---|---|---|---|
| Ion and Magnesium Ion | Li⁺ | Na⁺ | K⁺ | Mg²⁺ | Ca²⁺ | Mg²⁺Ca²⁺ |
| Changes in Concentration | 0.0 | 4.1 | 4.1 | 0.9 | 6.5 | 15.576 |
| [mg/L] over 0-15 min | | | | | | |
| Changes in Mole [mmol/L] | 0.000 | 0.178 | 0.105 | 0.036 | 0.162 | 0.481 |
| over 0-15 min | | | | | | |
| Changes in Equivalent | 0.000 | 0.178 | 0.105 | 0.072 | 0.324 | 0.679 |
| [mEq/L] over 0-15 min | | | | | | |

Table 3 and FIG. 3 show that the cations (Na⁺, K⁺, Mg²⁺, and Ca²⁺) leached during 15 minutes after the beginning of the test. The amount of increase in the above-mentioned four cations and the amount of decrease in the ammonium ions are similar, and thus, based on the charge balance, the decrease in the ammonia nitrogen (NH₄—N) concentration during 15 minutes after the beginning of the test can be attributed to the adsorption of ammonia nitrogen (NH₄—N) in the wastewater on the granulated coal ash by cation exchange.

### (Test Example 1-2) Citric Acid Solubility Evaluation for Granulated Coal Ash after Phosphorus Adsorption

The properties of phosphorus adsorbed on the granulated coal ash were compared to those on pumice conventionally used as filter media.

The granulated coal ash was washed with tap water, and the surface was further rinsed with distilled water. Then, the granulated coal ash was dried at 110° C. for 3 hours. 15 g of the resulting dried granulated coal ash was soaked in 500 mL of a 50 mg/L aqueous phosphoric acid solution for 24 hours to adsorb phosphorus, and then dried at room temperature (20° C.) for 24 hours. The resulting granulated coal ash with phosphorus adsorbed thereon to saturation was soaked in a 2% by mass citric acid solution (100 mL) for 24 hours, and then the granulated coal ash was removed from the citric acid solution. The T-P (total phosphorus) concentration in the citric acid solution was analyzed using a spectrophotometer manufactured by Shimadzu Corporation.

In a test with 0% citric acid (water), the liquid in which the granulated coal ash with phosphorus adsorbed thereon to saturation was soaked was changed from the 2% by mass citric acid solution to distilled water: otherwise, the T-P (total phosphorus) concentration was analyzed in the same manner as described above.

In a test using pumice, the granulated coal ash was replaced with pumice: otherwise, the T-P (total phosphorus) concentration in the citric acid solution and the T-P (total phosphorus) concentration in distilled water were analyzed in the same manner as described above, for pumice with phosphorus adsorbed thereon to saturation or pumice before soaking.

The results are shown in Table 4 and FIG. 4.

TABLE 4

| | Filter Media | | | | | | | |
|---|---|---|---|---|---|---|---|---|
| | | | Granulated Coal Ash | | | | Pumice (after | |
| | | | (after Phosphorus | | | | Phosphorus | |
| | Granulated Coal Ash | | Adsorption to | | Pumice (before | | Adsorption | |
| | (before Soaking) | | Saturation) | | Soaking) | | to Saturation) | |
| | with or without Citric Acid | | | | | | | |
| | | 2% by | | 2% by | | 2% by | | 2% by |
| | 0% | mass | 0% | mass | 0% | mass | 0% | mass |
| | citric | aqueous | citric | aqueous | citric | aqueous | citric | aqueous |
| | acid | citric acid | acid | citric acid | acid | citric acid | acid | citric acid |
| | (water) | solution | (water) | solution | (water) | solution | (water) | solution |
| T-P (mg/15 g- | 0 | 1.1 | 0.9 | 15.6 | 0 | 0.3 | 0.3 | 0.6 |
| Filtration Bed) | | | | | | | | |

The results in Table 4 and FIG. 4 show that phosphorus adsorbed on the granulated coal ash was adsorbed in the same form (citric acid-soluble) as that on slow-release fertilizers. Thus, phosphorus adsorbed on the granulated coal ash is not expected to be leached out by rain and the like, and is expected to remain adsorbed on the surface of the granulated coal ash until it is utilized by plants.

### (Test Example 1-3) Evaluation of Removal Performance for Hydrogen Sulfide in Wastewater

Backwash water in a septic tank was collected, the supernatant was removed, and the resulting water was centrifuged and concentrated to prepare concentrated sludge.

The prepared concentrated sludge (300 g) was added to septic tank effluent water (3 L), and sodium sulfate (3 g) was added thereto to obtain a sample liquid. The granulated coal ash (25 g) was placed in a 250 ml bottle, the sample liquid was poured into the bottle until full (the volume ratio of the septic tank-treated water to the granulated coal ash: 9:1), and the bottle was covered with a lid, such that hydrogen sulfide was produced. This point in time was defined as day 0. Four such bottles were prepared, and opened on days 0, 3, 6, and 7, and hydrogen sulfide concentrations were measured using PACKTEST (registered trademark) Sulfide (hydrogen sulfide) (manufactured by Kyoritsu Chemical-Check Lab., Corp.)

Pumice was used in place of the granulated coal ash: otherwise, hydrogen sulfide concentrations were measured in the same manner as described above. The water temperature was 30° C. in every case.

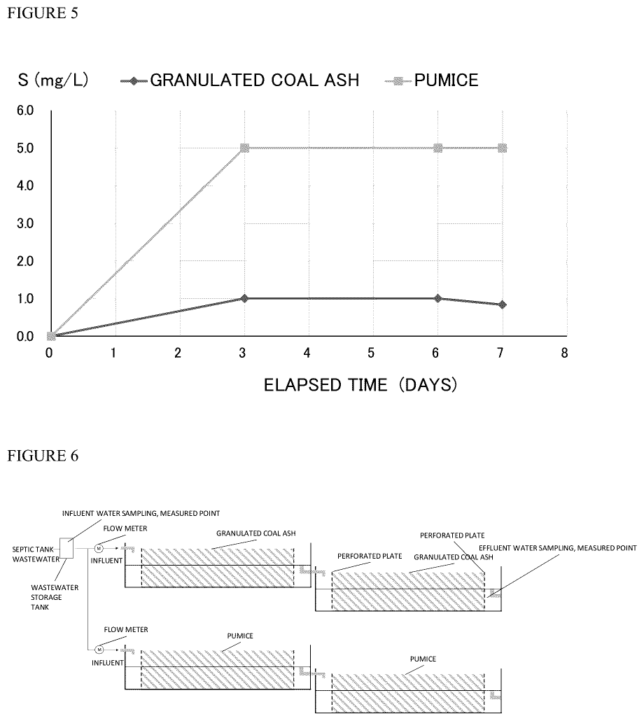

The results are shown in Table 5 and FIG. 5.

TABLE 5

Hydrogen Sulfide
Concentration (mg/L)

| Elapsed | Granulated | |
|---|---|---|
| Day(s) | Coal Ash | Pumice |
| 0 | 0.0 | 0.0 |
| 3 | 1.0 | 5.0 |
| 6 | 1.0 | 5.0 |
| 7 | 0.8 | 5.0 |

Table 5 and FIG. 5 show that compared to pumice, the granulated coal ash significantly reduces the hydrogen sulfide concentration in wastewater.

Thus, even if septic tank wastewater is placed in anaerobic conditions in the apparatus for water clarification and greening, which may cause production of hydrogen sulfide, which is harmful to plants, the granulated coal ash used as the filter media of the apparatus for water clarification and greening is expected to adsorb the hydrogen sulfide to maintain good plant growth. Furthermore, hydrogen sulfide, which is harmful to plants, can be prevented from being discharged out of the apparatus for water clarification and greening, so as to prevent effluent water from adversely affecting the ecology of a biotope pond and the like.

### Test Example 2 (Evaluation of Performance of Apparatus for Water Clarification and Greening)

### Apparatus for Water Clarification and Greening

A culture tank was prepared as follows: The inside of a fiber-reinforced plastic (FRP) container with an inner size of 165 cm in length, 59 cm in width, and 40 cm in height and an effective volume of 0.389 m³ was divided into three sections (an upstream section, a middle section, and a downstream section from the upstream side) by two perforated plates (3 mm thick polyvinyl chloride plates with 5 mm diameter holes formed at 10 mm intervals) and filled with filter media in the middle section (length: 135 cm). Two of these culture tanks were connected and used as a biogeofilter channel. An inlet was formed in a non-submerged position 35 cm from the bottom of the side surface of the upstream section, and an outlet was formed in a position 20 cm from the bottom of the side surface of the downstream section.

The middle section was divided into two sections in the longitudinal center by a perforated plate (height: 30 cm) of the same material as mentioned above (filtration bed capacity: 160 L). The middle section was filled with a granular material containing incineration ash or pumice as filter media to form a filtration bed. The volume of the filter media filled was 320 L per apparatus (two culture tanks).

The granulated coal ash (Hi-Beads (registered trademark) manufactured by Chugoku Electric Power Co.) was used as the granular material containing incineration ash. Two types of the granulated coal ash with different particle diameters were used. The granulated coal ash with a particle diameter of 10 to 20 mm was placed to a height of about 20 cm from the bottom (about 91 kg: volume: 91 L), and the granulated coal ash with a particle diameter of 5 mm or more and less than 10 mm was placed on the above-mentioned granulated coal ash to a height of about 15 cm (height of about 35 cm from the bottom) (about 69 kg: volume: 69 L).

Pumice with a particle diameter of 5 to 10 mm was used and placed to a height of about 35 cm from the bottom.

Septic tank wastewater was fed into each culture tank through the inlet to the upstream section to a height of about 20 cm from the bottom.

Plants were planted in the filtration bed. Feed crops or flowering plants were used as the plants. The feed crops used were rye (upstream region of the middle section) and leaf mustard (downstream region of the middle section). The flowering plant used in the upstream region of the middle section was more than one from calendula, garden cyclamen, primula julienne, pansy, viola, ornamental cabbage, dusty miller, and tulip, and the plant used in the downstream region of the middle section was Thuja orientalis. When the granulated coal ash was used as the filter media, the plants were planted in the granulated coal ash with a particle diameter of 5 mm or more and less than 10 mm above the water surface.

The apparatuses for water clarification and greening used in the test were as follows:

Apparatus 1 (example): filter media granulated coal ash (two types with different particle diameters were used.)
plants feed crops (rye in an upstream region of the middle section; and leaf mustard in a downstream region of the middle section)

Apparatus 2 (example): filter media granulated coal ash (two types with different particle diameters were used.)
plants flowering plants (three plants each of calendula, garden cyclamen, primula julienne, pansy, viola, ornamental cabbage, dusty miller, and tulip in an upstream region of the middle section; and Thuja orientalis in a downstream region of the middle section)

Apparatus 3 (comparative example):
filter media pumice
plants feed crops (rye in an upstream region of the middle section; and leaf mustard in a downstream region of the middle section)

Apparatus 4 (comparative example):
filter media pumice
plants flowering plants (three plants each of calendula, garden cyclamen, primula julienne, pansy, viola, ornamental cabbage, dusty miller, and tulip in an upstream region of the middle section; and Thuja orientalis in a downstream region of the middle section)

Apparatus 5 (comparative example):
filter media granulated coal ash (two types with different particle diameters were used.)
plants none (not planted)

Apparatus 6 (comparative example):
filter media pumice
plants none (not planted)

### Operating Conditions

Each apparatus was installed outdoors in a sunny location. Septic tank wastewater was temporarily stored in a wastewater storage tank, and the wastewater was fed from the tank into each apparatus (two culture tanks) through the inlet over 24 hours evenly at 120 L/day per apparatus. The water to be treated, passed through the upstream section, middle section, and downstream section of the upstream culture tank, and then the upstream section, middle section, and downstream section of the downstream culture tank in this order, was discharged through the outlet, which was formed on the side surface of the downstream section of the downstream culture tank.

The operating conditions for each apparatus were as shown below:
Feed rate of the water to be treated: 120 L/day
Linear velocity (L.V.): 1.02 m/day
Space velocity (S.V.): 0.38/day
Total nitrogen concentration in the water to be treated: about 70 mg/L
Total phosphorus concentration in the water to be treated: about 10 mg/L

The experiment continued for the set number of days as described below. No operations such as backwashing of the filtration bed were performed during the experiment period.

Nitrogen and phosphorus concentrations were measured daily to investigate the quality of the resulting treated water. The measured nitrogen concentrations were the ammonia nitrogen (NH₄—N) concentration and total nitrogen (T-N) concentration. The measured phosphorus concentration was the total phosphorus (T-P) concentration.

### (Test Example 2-1) pH

First, pH change in the case of passing wastewater into a channel without plants was investigated.

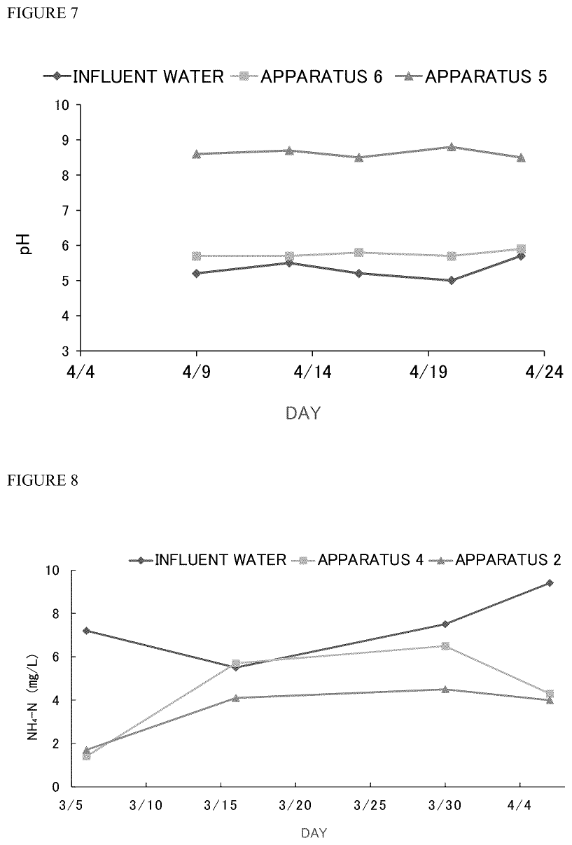

Apparatuses 5 and 6 mentioned above were placed as shown in FIG. 6 and performed water clarification treatment under the operating conditions mentioned above, during the period from April 9th to 24th. The pHs of the influent and effluent water were measured with a pH meter (portable pH meter HM-37P manufactured by DDK-TOA Corporation). The influent water was sampled from the wastewater storage tank, and the effluent water was sampled from the downstream section of the downstream culture tank. The results are shown in Table 6 and FIG. 7.

TABLE 6

| | pH | | |
|---|---|---|---|
| | Influent | Apparatus | Apparatus |
| Day | Water | 5 | 6 |
| 4/9 | 5.2 | 8.6 | 5.7 |
| 4/13 | 5.5 | 8.7 | 5.7 |
| 4/16 | 5.2 | 8.5 | 5.8 |
| 4/20 | 5 | 8.8 | 5.7 |
| 4/23 | 5.7 | 8.5 | 5.9 |

Table 6 and FIG. 7 show that even when the pH of the incoming water to be treated was low (around 5), the pH of the effluent water from apparatus 5, filled with the granulated coal ash as the filter media, fell in a neutral to weakly alkaline range. Thus, even if the apparatus is fed with wastewater with a low pH, such as wastewater containing human waste, the apparatus can maintain a weakly alkaline state by the action of the granulated coal ash. Thus, the nitrification performance of the apparatus for water clarification and greening can be maintained. On the other hand, in apparatus 6 using pumice as the filter media, the pH of the effluent water did not rise to 6. In contrast, the pH of the effluent water from apparatus 5 using the granulated coal ash as the filter media fell in a neutral to weakly alkaline range (more than 7 and 9 or less).

### (Test Example 2-2) Ammonia Nitrogen (NH₄—N) and Total Phosphorus (T-P) Concentrations in Winter

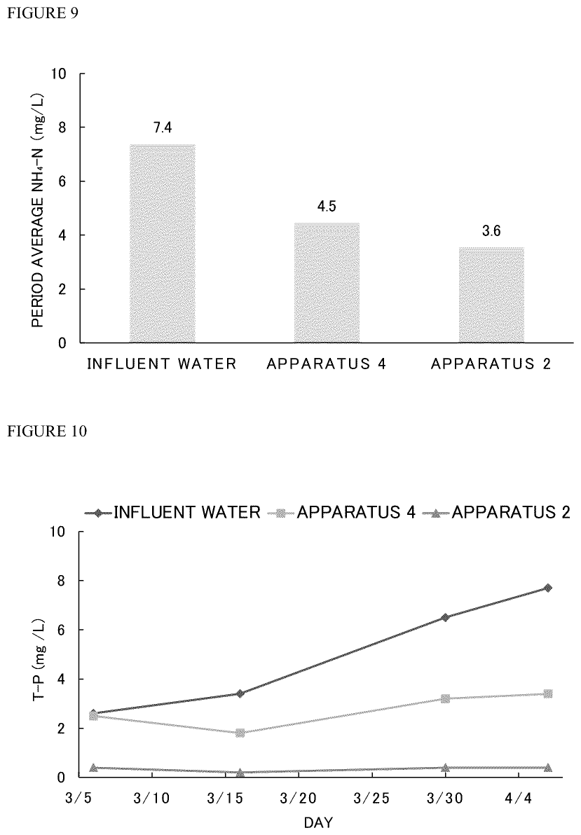

Apparatuses 2 and 4 mentioned above were placed in the same manner as described above (Test Example 2-1). The apparatuses performed water clarification treatment during the period from March 6th to April 6th under the same operating conditions as in Test Example 2, except that the total nitrogen concentration in the water to be treated was changed to about 20 mg/L, and the total phosphorus concentration in the water to be treated was changed to about 5 mg/L. Then, the ammonia nitrogen (NH₄—N) and total phosphorus (T-P) concentrations in the influent and effluent water were measured. The results are shown in Table 7. FIG. 8 shows changes over time in ammonia nitrogen (NH₄—N) concentration, and FIG. 9 shows period average values thereof. FIG. 10 shows changes over time in total phosphorus (T-P) concentration, and FIG. 11 shows period average values thereof.

TABLE 7

| | NH₄—N (mg/L) | | | T-P (mg/L) | | |
|---|---|---|---|---|---|---|
| | | Apparatus 4 | Apparatus 2 (Ex.) | | Apparatus 4 | Apparatus 2 (Ex.) |
| | | (Comp. Ex.) | Granulated | | (Comp. Ex.) | Granulated |
| | | Pumice, | Coal Ash, | | Pumice, | Coal Ash, |
| | Influent | Flowering | Flowering | Influent | Flowering | Flowering |
| Date | Water | Plants | Plants | Water | Plants | Plants |
| 3/6 | 7.2 | 1.4 | 1.7 | 2.6 | 2.5 | 0.4 |
| 3/16 | 5.5 | 5.7 | 4.1 | 3.4 | 1.8 | 0.2 |
| 3/30 | 7.5 | 6.5 | 4.5 | 6.5 | 3.2 | 0.4 |
| 4/6 | 9.4 | 4.3 | 4 | 7.7 | 3.4 | 0.4 |
| Period | 7.4 | 4.5 | 3.6 | 5.1 | 2.7 | 0.4 |
| Average | | | | | | |
| Period | 1.38 | 1.94 | 1.10 | 2.11 | 0.63 | 0.09 |
| SD | | | | | | |

Table 7, and FIGS. 8 and 9 show that compared to using pumice as the filter media, using the granulated coal ash results in lower ammonia nitrogen concentrations in the water to be treated. Table 7, and FIGS. 10 and 11 also show that compared to using pumice as the filter media, using the granulated coal ash results in lower total phosphorus concentrations in the water to be treated.

These results show that because of excellent nitrogen and phosphorus removal performance of the granulated coal ash used as the filter media, the apparatus for water clarification and greening using the granulated coal ash as the filter media can maintain stable nitrogen and phosphorus removal performance, even in winter when plant growth is stagnant, and plants absorb less nitrogen and phosphorus.

### (Test Example 2-3) Ammonia Nitrogen (NH₄—N) and Total Phosphorus (T-P) Concentrations in Summer

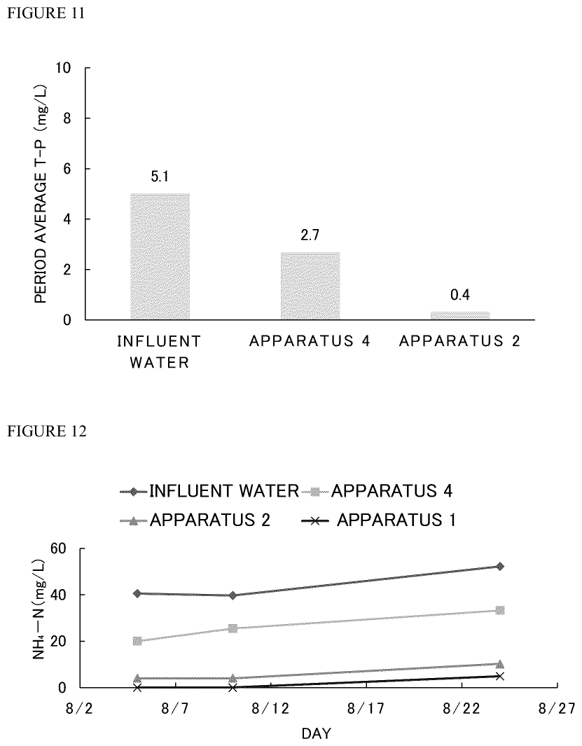

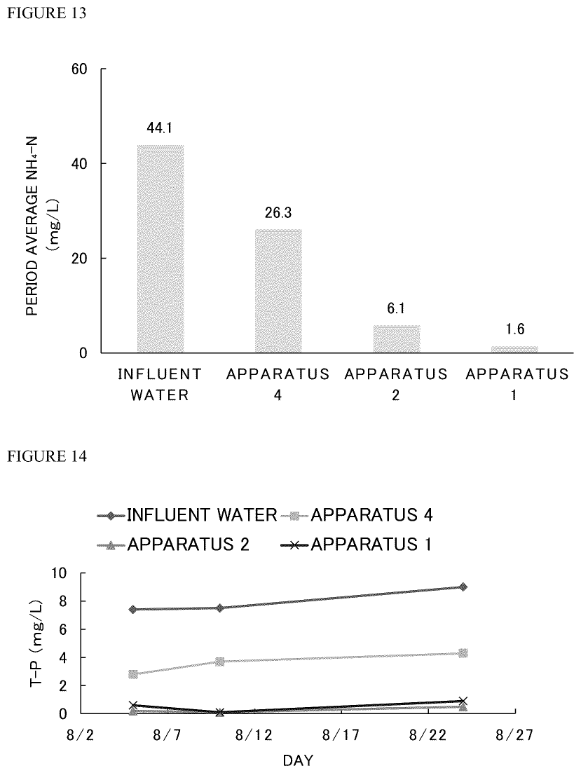

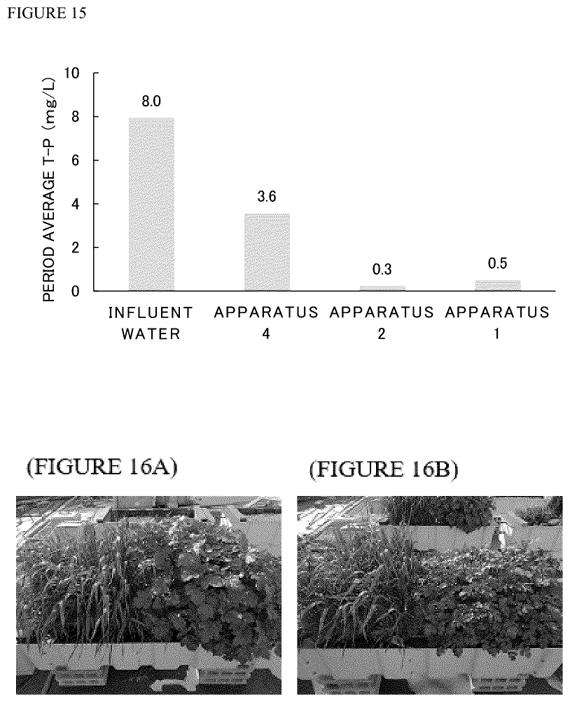

Apparatuses 1, 2 and 4 mentioned above were placed in the same manner as described above (Test Example 2-1) and performed water clarification treatment under the same operating conditions as in Test Example 2, during the period of August 5th to 24th. Then, the ammonia nitrogen (NH₄—N) and total phosphorus (T-P) concentrations in the influent and effluent water were measured. These results are shown in Table 8. FIG. 12 shows changes over time in the ammonia nitrogen (NH₄—N) concentration, and FIG. 13 shows period average values thereof. FIG. 14 shows changes over time in total phosphorus (T-P) concentration, and FIG. 15 shows period average values thereof.

TABLE 8

| | NH₄—N (mg/L) | | | | T-P (mg/L) | | | |
|---|---|---|---|---|---|---|---|---|
| | | | Apparatus | | | | Apparatus | |
| | | Apparatus 4 | 2 (Ex.) | Apparatus | | Apparatus 4 | 2 (Ex.) | Apparatus |
| | | (Comp. Ex.) | Granulated | 1 (Ex.) | | (Comp. Ex.) | Granulated | 1 (Ex.) |
| | | Pumice, | Coal Ash, | Granulated | | Pumice, | Coal Ash, | Granulated |
| | Influent | Flowering | Flowering | Coal Ash, | Influent | Flowering | Flowering | Coal Ash, |
| Date | Water | Plants | Plants | Crops | Water | Plants | Plants | Crops |
| 8/5 | 40.5 | 20.1 | 4.0 | 0.0 | 7.4 | 2.8 | 0.2 | 0.6 |
| 8/10 | 39.7 | 25.5 | 4.0 | 0.0 | 7.5 | 3.7 | 0.1 | 0.1 |
| 8/24 | 52.2 | 33.3 | 10.2 | 4.9 | 9.0 | 4.3 | 0.5 | 0.9 |
| Period | 44.1 | 26.3 | 6.1 | 1.6 | 8.0 | 3.6 | 0.3 | 0.5 |
| Average | | | | | | | | |

Table 8, and FIGS. 12 and 13 show that in summer when plant growth is vigorous, apparatuses 1 and 2 using the granulated coal ash as the filter media significantly reduce the ammonia nitrogen concentration, compared to apparatus 4 using pumice as the filter media. This is because the plants (feed crops or flowering plants) grow by absorbing ammonia nitrogen adsorbed on the granulated coal ash used as the filter media.

Table 8, and FIGS. 14 and 15 show that in summer, apparatuses 1 and 2 using the granulated coal ash as the filter media significantly reduce the total phosphorus concentration, compared to apparatus 4 using pumice as the filter media. This is because in summer when plant growth is vigorous, the phosphorus in wastewater previously adsorbed on the granulated coal ash is absorbed by the plant roots, which causes regeneration of phosphorus adsorption sites in the granulated coal ash, and allows the phosphorus in wastewater to be adsorbed thereon.

### (Test Example 2-4) Evaluation of Plant Growth

Using apparatus 1 (apparatus in which the granulated coal ash was used as the filter media, and feed crops (rye and leaf mustard) were planted as plants) and apparatus 3 (apparatus in which pumice was used as the filter media, and feed crops (rye and leaf mustard) were planted as plants), water clarification and greening treatment was performed during the period from Dec. 24, 2020 to Mar. 4, 2021, and then the height of the plants was measured. The results are shown in Table 9. FIG. 16 shows photographs of the plants (rye and leaf mustard) taken after the treatment. FIG. 16A on the left shows a photograph of apparatus 1, and FIG. 16B on the right shows a photograph of apparatus 3.

TABLE 9

| | |
|---|---|
| Apparatus 1 (Ex.) | Apparatus 3 |
| Granulated | (Comp. Ex.) |
| Coal Ash | Pumice |

| | | Leaf | | Leaf |
|---|---|---|---|---|
| | Rye | Mustard | Rye | Mustard |
| Date | (cm) | (cm) | (cm) | (cm) |
| 2020 Dec. 24 | 18 | 18 | 15 | 10 |
| 2021 Jan. 7 | 20 | 22 | 18 | 11 |
| 2021 Jan. 28 | 29 | 28 | 25 | 20 |
| 2021 Feb. 22 | 58 | 60 | 50 | 40 |
| 2021 Mar. 4 | 75 | 75 | 67 | 60 |

Table 9 and FIG. 16 show that, after 70 days of the water clarification and greening treatment in winter, the height of the plants in apparatus 1 (filter media: granulated coal ash, plants: rye and leaf mustard) (FIG. 16A) was 1.12 to 1.25 times higher than that in apparatus 3 (filter media: pumice, plants: rye and leaf mustard) (FIG. 16B).

Furthermore, using apparatus 2 (apparatus in which the granulated coal ash was used as the filter media, and flowering plants (zinnia, ivy, sedum, and kochia) were planted as plants) and apparatus 4 (apparatus in which pumice was used as the filter media, and flowering plants (zinnia, ivy, sedum, and kochia) were planted as plants), water clarification and greening treatment was performed in the same manner as described above for 42 days in summer, and then the height of the plants was measured. As a result, the height of the plants in apparatus 2 was 1.07 to 1.52 times higher than that in apparatus 4 (values not shown).

These results show that in the apparatus for water clarification and greening using the granular material containing incineration ash as the filter media, plant growth was improved by the plants absorbing components such as nitrogen and phosphorus adsorbed on the granular material containing incineration ash.

### REFERENCE SIGNS LIST

1: biogeofilter channel (apparatus for water clarification and greening)
2: filter media
3: plants
4: culture tank
5: perforated plate
6: upstream section
7: middle section
8: downstream section
9: inlet
10: outlet

1. A method for water clarification and greening, which simultaneously achieves water clarification and greening by planting a plant in a channel;
wherein water flowing into the channel contains ammonia nitrogen and/or phosphorus;
the channel comprises a planting portion where the plant is planted in a filtration bed filled with a granular material containing incineration ash; and
the granular material containing incineration ash adsorbs the ammonia nitrogen and/or phosphorus in the water flowing into the channel, and the plant grows by absorbing the ammonia nitrogen and/or phosphorus adsorbed onto the granular material containing incineration ash, so as to achieve water clarification and greening.

2. The method according to claim 1, wherein the water containing ammonia nitrogen and/or phosphorus is wastewater from a septic tank.

3. The method according to claim 1, wherein the granular material containing incineration ash releases a fertilizer component containing at least one metal ion selected from the group consisting of an alkali metal ion, a calcium ion, and a magnesium ion.

4. The method according to claim 1, wherein the phosphorus adsorbed onto the granular material containing incineration ash is soluble in citric acid.

5. The method according to claim 1, wherein the water flowing into the channel further contains a sulfuric acid salt, and, when hydrogen sulfide is produced from the sulfuric acid salt, the method can remove the hydrogen sulfide.

6. The method according to claim 1, wherein the method can adjust the pH in a neutral to weakly alkaline range.

7. The method according to claim 1, wherein the granular material containing incineration ash is a granulated material containing coal ash and cement.

8. The method according to claim 1, wherein the method can adjust an amount of adsorption of the ammonia nitrogen and/or phosphorus.

9. A fertilizer composition comprising the granular material containing incineration ash after use in the method according to claim 1.

10. An apparatus for water clarification and greening, which simultaneously achieves water clarification and greening by planting a plant in a channel;
wherein water flowing into the channel contains ammonia nitrogen and/or phosphorus;
the channel comprises a planting portion where the plant is planted in a filtration bed filled with a granular material containing incineration ash; and
the granular material containing incineration ash adsorbs the ammonia nitrogen and/or phosphorus in the water flowing into the channel, and the plant grows by absorbing the ammonia nitrogen and/or phosphorus adsorbed onto the granular material containing incineration ash, so as to achieve water clarification and greening.

11. The apparatus according to claim 10, wherein the channel comprises three sections, which are an upstream section, a middle section, and a downstream section, from the upstream side; and
the middle section comprises the planting portion.

12. The apparatus according to claim 11, wherein the upstream section comprises an inlet on an upstream side surface, and allows wastewater from a septic tank to flow into the upstream section through the inlet and allows suspended solids in the wastewater to settle and be removed;
the middle section is the planting portion where the plant is planted in the filtration bed filled with the granular material containing incineration ash, wherein the granular material containing incineration ash adsorbs the ammonia nitrogen and/or phosphorus in the wastewater that has passed the upstream section, and the plant grows by absorbing the ammonia nitrogen and/or phosphorus adsorbed onto the granular material containing incineration ash; and
the downstream section comprises an outlet on a downstream side surface, and allows suspended solids in the wastewater that has passed the middle section to settle and be removed and allows treated water to be discharged through the outlet.
